(19) United States
(12) Patent Application Publication
(10) Pub. No.: US 2005/0289030 A1
(43) Pub. Date: Dec. 29, 2005

(54) System and method for financial institution account deposits via retail merchants

(76) Inventor: Maurice R. Smith, Cary, NC (US)

Correspondence Address: COATS & BENNETT, PLLC, P O BOX 5, RALEIGH, NC, 27602, US

(21) Appl. No.: 10/875,252

(22) Filed: Jun. 24, 2004

(51) Int. Cl. G06F 17/60

(52) U.S. Cl. 705/35; 705/42; 705/43; 705/39

(57) ABSTRACT

Deposits to a customer account at a financial institution are received by a retail merchant, and deposited to the customer account. The funds may comprise cash or a negotiable instrument such as a paycheck. The funds deposited by the retail merchant may comprise all or a portion of the funds received by the customer. The deposit is preferably performed by a credit operation to a customer's debit card issued for the account, through a transaction processing system, where the credit is not a credit for previously debited funds. The financial institution may pay fees to the retail merchant, and/or may indemnify the retail merchant for losses due to failure of negotiable instruments received for deposit.

### BACKGROUND

The present invention relates generally to the field of financial transactions, and in particular to a system and method by which customers of financial institutions can make deposits to their accounts through selected retail merchants.

A persistent and ongoing trend in the banking industry over at least the past fifty years is an increasing level of convenience provided to the customers of financial institutions. Originally, banks operated a large, downtown facility to which all customers came to conduct their banking transactions. The opening of a plurality of smaller branches in the suburbs increased banking customers' convenience. The provision of drive-up windows at these branches furthered this trend. As information technology advanced, automated teller machines (ATMs) proliferated. A recent development is the provision of “micro-branches” in malls and large retail facilities, such as grocery stores. While this trend has proliferated the locations at which one may conduct certain banking transactions, they are not yet ubiquitous. Furthermore, in some cases, the increased convenience comes at a premium to the customer (such as network fees imposed on the use of other banks' or networks' ATMs).

Another trend in the banking industry is the increasing use of debit cards—also referred to in the art as check cards—to replace the use of personal checks in retail purchase transactions. Debit cards operate in a manner similar to credit cards, and typically operate through the same broad-based transaction processing systems developed for credit cards, such as Visa®, MasterCard®, and the like. A debit card differs from a credit card primarily in that a purchase transaction using a debit card results in an immediate debit of the customer's account at the card-issuing financial institution (i.e., no credit is extended to complete the transaction). Funds debited from a customer's account using a debit card may be credited back to the account, such as in the event a customer returns merchandise to a retailer, a debit was erroneously posted, or the like. However, because the debit card is modeled on writing personal checks, it is limited (with the exception of posting credits of previously debited funds) to debiting customer accounts, and does not support making deposits by customers.

### SUMMARY

In one aspect, the present invention relates to a method of depositing funds to a customer account at a financial institution by a retail merchant. Funds are accepted by a retail merchant from a customer for deposit into at least one customer account at a financial institution. Information identifying the customer account is obtained from the customer. At least a portion of the funds is deposited into the customer account, the deposit not being a credit of previously debited funds.

In another aspect, the present invention relates to a method of depositing, by a financial institution, funds received by a retail merchant from a customer of the financial institution, into the customer's account at the financial institution. Information identifying at least one account of a customer of the financial institution is received, at the financial institution, sent by the retail merchant. A deposit to the account is authorized. Funds sent by the retail merchant are received, the funds being received by the retail merchant from the customer. At least a portion of the funds are deposited into the customer account, the deposit not a credit of funds previously debited from the account.

In yet another aspect, the present invention relates to a system for depositing funds received by a retail merchant from a customer into the customer's account at a financial institution. The system includes a point-of-sale terminal at the retail merchant operative to receive at least information identifying a customer's account at a financial institution and an amount of funds. The system also includes an account access terminal at the financial institution operative to receive information identifying the customer's account and credit for at least a portion of the funds, and to credit the account with the received funds. The system further includes a transaction processing system communicatively coupled to the point-of-sale terminal and the account access terminal and operative to transfer a credit for at least a portion of the funds from the point-of-sale terminal to the account access terminal for credit to the account, the credit not a credit of funds previously debited from the account.

In still another aspect, the present invention relates to a method of operating a transaction processing system by a retail merchant to deposit funds received by the merchant from a financial institution customer into the customer's account at the financial institution. Funds and information identifying the customer account are received from the customer. A procedure is performed via the transaction processing system, provided by the transaction processing system to credit to the customer account funds previously debited via the transaction processing system from the customer account, to deposit at least a portion of the funds in the customer account, the funds not previously debited from the customer account.

### BRIEF DESCRIPTION OF DRAWINGS

FIG. 1 is a functional block diagram depicting the flow of funds according to the present invention.

FIG. 2 is a transaction flow diagram depicting both the traditional debit card transaction process and a method of deposits according to one embodiment of the present invention.

FIG. 3 is a block diagram of a representative computer and communications system for carrying out the present invention.

### DETAILED DESCRIPTION

The present invention relates to a system and method of depositing funds into customer financial institution accounts by retail merchants. This effectively turns the retail merchant into a “branch” of the financial institution, with respect to certain banking transactions, such as deposits. According to the present invention, a retail merchant may accept funds from a customer of a financial institution, and deposit some or all of the funds into the customer's account. The funds may be in the form of cash, or a negotiable instrument, such as a check from a third party. In particular, the funds may comprise the customer's paycheck. Rather than be forced to make a trip to a branch of his financial institution or to an ATM (possibly incurring network access fees if the ATM is not provided by his financial institution), the customer may deposit his paycheck as an incident to performing a routine retail transaction, such as purchasing groceries, renting a video, or the like.

A financial institution may selectively recruit retail merchants to accept customer deposits according to the present invention—for example, selecting retail merchants in geographic areas in which the financial institution does not maintain a branch or ATM. Alternatively or additionally, the financial institution may authorize the system and method of the present invention for a group of related retail merchants, such as all franchisees or members of a “chain” of restaurants, rental stores, retailers, or the like.

The present invention benefits the financial institution by increasing the convenience of its customers, hence providing a competitive advantage and allowing it to recruit more customers. Additionally, the present invention benefits the retail merchant by providing a convenient service to existing customers who are also customers of the financial institution, and additionally by enticing other customers of the financial institution into the retail merchant's premises, where they may make purchases. In one embodiment, retail merchants may both promote and capitalize on the present invention by offering a premium to customers who deposit funds according to the present invention. For example, a retail merchant may offer discounted or free merchandise, rental, services or the like to a customer who, concomitant with the purchase transaction, deposits funds in excess of some predetermined minimum amount into an account at a financial institution. Finally, the present invention benefits customers of the financial institution, by increasing the availability and convenience of avenues by which to conduct certain banking transactions, such as deposits to their accounts.

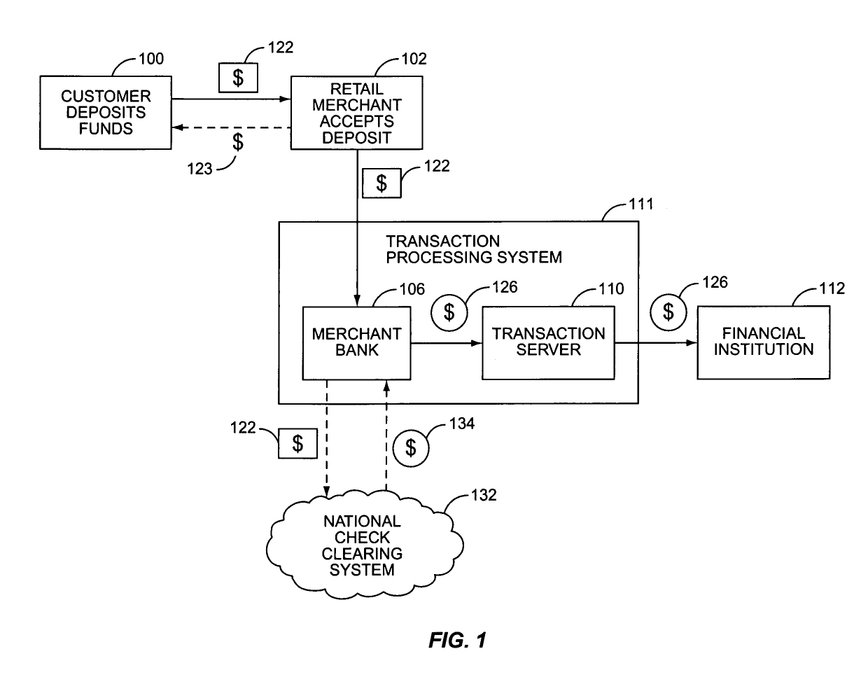

The process of a customer depositing funds to his account according to the present invention is depicted in FIG. 1. A customer 100 deposits funds 122 at a retail merchant 102. The funds 122 may comprise cash or a negotiable instrument, such as a paycheck. In the latter case, the customer may designate the entire face value of the negotiable instrument as a deposit, or alternatively may designate some portion of that value for deposit, receiving the balance in cash 123 from the retail merchant 102. The retail merchant deposits the customer's funds 122 (either cash or a negotiable instrument), along with its receipts from other customers, at a financial institution where it maintains an account, referred to herein as the merchant bank 106.

The merchant bank 106 sends an electronic credit 126, representing at least part of the customer's funds 122, to a transaction server 110. The merchant bank 106 and transaction server 110 (and optionally the customer's financial institution 112) are part of a transaction processing system 111 that transfers electronic funds credits and debits between participating financial institutions. The transaction server 110 forwards the electronic credit 126 to the customer's financial institution 112, where funds equaling the electronic credit 126 are deposited into the customer's account. The electronic credit 126 may be less than the amount of the customer's funds 122. For example, the electronic credit 126 may be less than the amount of the customer's funds 122 by the amount of cash 123 the customer 100 received from the retail merchant 102. As another example, in one embodiment, the retail merchant 102 may retain a transaction fee from the customer's funds 122, and the electronic credit 126 may be less than the customer's funds 122 by the amount of the fee.

If the customer funds 122 comprise a negotiable instrument, the merchant bank 106 provisionally credits the account of the retail merchant 102, and additionally sends the negotiable instrument to the national check clearing system 132. If the negotiable instrument clears, the merchant bank 106 will receive an electronic credit 134 for the face value of the negotiable instrument and make the provisional credit permanent. There exists a possibility that the negotiable instrument will fail to clear, as being forged, drawn against an account with insufficient funds, or the like. In this case, the merchant bank 106 will rescind the provisional credit to the retail merchant 102. Thus, the retail merchant 102 assumes some risk in accepting negotiable instruments from the customer 100 for deposit in the customer's financial institution 112 account. To encourage the retail merchant 102 to adopt the deposit methodology according to the present invention, the financial institution 112 may indemnify the retail merchant 102 against such losses. Alternatively, the financial institution 112 may pay the retail merchant a sufficient per-deposit fee (or alternatively, authorize such a fee to be withheld by the retail merchant 102 from the customer funds 122 deposited) sufficient that the retail merchant 102 will assume the risk of failed negotiable instruments.

According to the present invention, a retail merchant 102 may make deposits to a customer account at a financial institution 112 by use of the customer's debit card 101 issued in association with the account. The retail merchant 102 preferably deposits the funds via a transaction processing system 111, which is preferably the same transaction processing system 111 utilized to process debit transactions conducted with the debit card 101. In this case, the present invention adds valuable functionality to the existing transaction processing system 111, without requiring any modification or reprogramming of the transaction processing system 111 or its constituent servers.

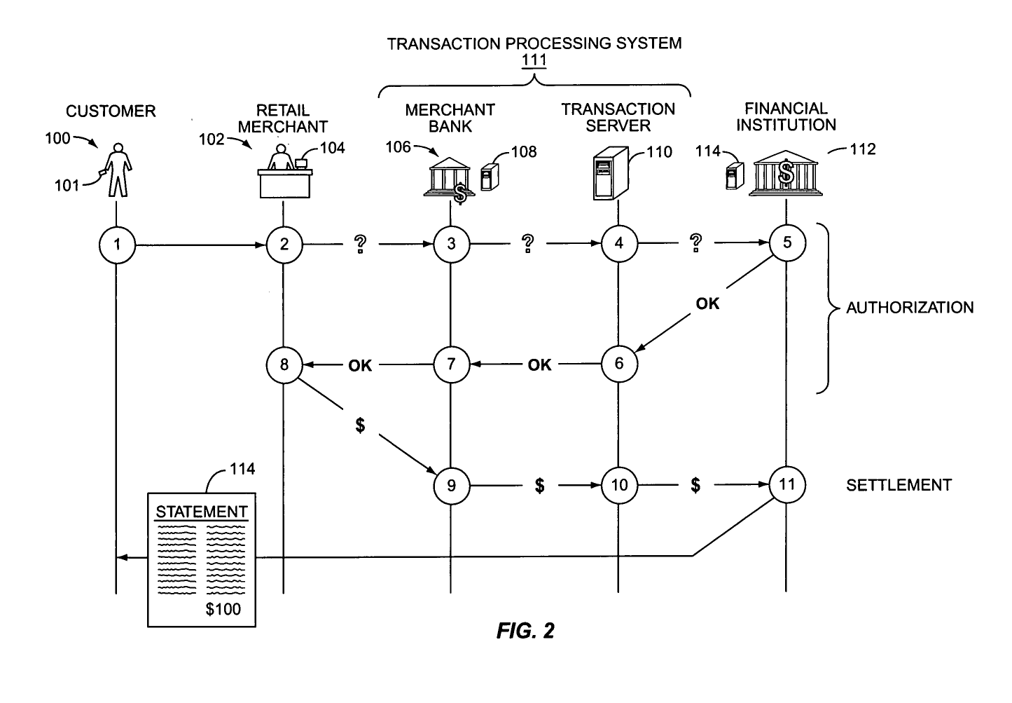

FIG. 2 depicts both the existing operation of a debit card 101 transaction, and the use of the transaction processing system 111 to effect customer 100 deposits by a retail merchant 102 according to the present invention. The transaction process may be generally divided into two phases, or procedures: an authorization procedure, comprising Steps 1-8; and a settlement procedure, comprising Steps 9-11. The conventional use of the transaction processing system 111 to implement a debit card 101 purchase by a customer 100 is described first.

At Step 1, a customer 100 uses a debit card 101 to purchase goods or services from a retail merchant 102. At Step 2, the retail merchant 102 enters the dollar amount and account information related to the debit card 101 into a point-of-sale (POS) terminal 104. These processes may be automated. For example, the price may be optically scanned from a bar code on the product, and the account information may be extracted from the card 101 by swiping the card 101 through a card reader, which reads data encoded in a magnetic strip on the card 101. Alternatively, the account information may be optically scanned from a bar code or other optical encoding on the card 101. As another example, the card 101 may include circuitry (known in the art as a “smart card”), whereby the account information may be read directly by the POS terminal 104. As yet another example, the card 101 may include a Radio Frequency Identification (RFID) circuit operative to transmit information from the card 101 to a card reader by RF electromagnetic radiation. As used herein, the term “card” or “debit card” refers to any device carried by a customer that is operative to transfer account information to a POS terminal 104. In addition to the traditional wallet-size plastic card format, credit and debit cards 101 are available in a variety of smaller form factors, such as a “flip out” card pivotally mounted in a key fob. Additionally, particularly with respect to RFID circuits, the card 101 may assume virtually any size or shape.

Upon obtaining account information form the customer's card 101, and optionally upon the customer entering a Personal Identification Number (PIN) into the POS terminal 104 for additional security, the retail merchant 102 transmits an authorization request (including at least the dollar amount and account information) to the merchant bank 106.

At Step 3, the merchant bank 106 receives the authorization request at a transaction processing terminal 108 and forwards it to the transaction server 110 of a transaction processing system 111. The merchant bank 106 and the transaction server 110 together comprise a part of the transaction processing system 111. In general, the transaction processing system 111 may include additional intermediary banks or financial institutions, and additional routers, auditors, and other entities that are not germane to the present invention and are not discussed further herein. The customer's financial institution 112 may be part of the transaction processing system 111. At Step 4, the transaction server 110 routes the authorization request to an account access terminal 114 at the customer's financial institution 112, based on the account information obtained from the debit card 101. At Step 5, the financial institution 112 authorizes or declines the transaction, based on the amount requested, the funds available in the customer's account, a verification of the customer's PIN, and/or other factors.

The financial institution 112 sends the authorization (e.g., approval or denial) for the transaction to the transaction server 110, which at Step 6 forwards the authorization to the merchant bank 106. The merchant bank 106 forwards the authorization to the retail merchant 102 who at Step 8 completes or aborts the transaction accordingly.

The foregoing steps comprise the authorization procedure of the transaction. If the authorization procedure completes successfully, a clearing and settlement process is initiated at Step 8 when the retail merchant 102 deposits the transaction receipt with the merchant bank 106. At Step 9, the merchant bank 106 credits the merchant's account and electronically submits a debit request to the transaction server 110. At Step 10, the transaction server 110 pays the merchant bank 106 and debits the financial institution 112 account, then forwards a debit request to the financial institution 112. At Step 11, the financial institution 112 debits the customer's account, and at some later time sends the customer a monthly statement 114 reflecting the debit to the customer's account.

The transaction processing system 111 includes provisions for crediting the customer's account at the financial institution 112 by the retail merchant 102. For example, a customer who purchased merchandise from the retail merchant 102 using the debit card 101 may subsequently return the merchandise to the retail merchant 102 and request a refund. The retail merchant 102 may then credit the customer's financial institution 112 account in a manner similar to that described above for debiting the account (the difference being that the financial amount depicted between steps 8, 9 and 10 represents a debit in the case of a purchase, and a credit in the case of a refund). However, the credit process is only initiated to credit funds to the customer's account that were previously debited.

According to the present invention, a retail merchant 102 may accept funds from a customer 100 for deposit in the customer's account at the financial institution 112, the funds not being a credit for funds previously debited from the account. That is, according to the present invention, the retail merchant 102 may initiate a credit process with the transaction processing system 111 to deposit funds into a customer's account ab initio, or in the first instance.

The method of deposit by a retail merchant 102 according to the present invention is also described with reference to FIG. 1. At Step 1, a customer 100 presents the retail merchant 102 with funds that the customer wishes to deposit to his account at a financial institution 112. These funds may comprise cash, a negotiable instrument such as a paycheck, or the like. At Step 2, the retail merchant 102 accepts the funds. In the case of a negotiable instrument such as a paycheck, the retail merchant 102 may engage in various security procedures, such as verifying the identity of the customer 100 via identification, verifying the signature on and endorsement of the negotiable instrument, or the like. The retail merchant 102 then enters the dollar amount of the funds to be deposited into a POS terminal 104, and obtains account information from the customer's debit card 101, as described above. The retail merchant 102 may additionally require the customer 100 to enter a PIN into the POS terminal 104.

The retail merchant 102 submits an authorization request for the deposited funds to the merchant bank 106 at Step 2. At Step 3, the merchant bank 106 forwards the authorization request to the transaction server 110. At Step 4, the transaction server 110 routes the authorization request to the financial institution 112. At Step 5, the financial institution 112 authorizes or declines the authorization request (such as by verifying that the account exists and is active, and verifying the correct PIN). If the deposit is approved, the financial institution 112 sends the authorization to the transaction server 110. At Step 6, the transaction server 110 forwards the authorization to the merchant bank 106, which at Step 7 forwards the authorization to the retail merchant 102.

At Step 8, the retail merchant 102 accepts the authorization and begins the settlement process by electronically forwarding the transaction to the merchant bank 106 (alternatively, a cash deposit may be deposited with the merchant bank 106 at the close of business, with the retail merchant's other customer receipts). The retail merchant 102 also submits the negotiable instrument, if any, to the merchant bank 106. At Step 9, the merchant bank 106 debits the retail merchant's account for the amount of the deposit, and provisionally credits the retail merchant's account for the face value of the negotiable instrument. The merchant bank 106 then processes the negotiable instrument through the national check clearing system 132 (see FIG. 1).

At Step 9 the merchant bank 106 forwards a credit for the funds designated for deposit (which may comprise less than the funds the customer 100 gave the retail merchant 102) to the transaction server 110, which at Step 10 routes the funds to the financial institution 112. At Step 11, the financial institution 112 deposits the funds into the customer's account (optionally retaining a processing fee). The financial institution 112 later sends the customer a monthly statement 114 reflecting the deposit.

In this manner, the existing and widely deployed transaction processing system 111 is utilized to provide the novel and useful functionality of allowing a retail merchant 102 to accept deposits from a customer 100 into the customer's account at his financial institution 112. This allows the financial institution 112 to establish potentially thousands of “branches” with respect to the ability of customers 100 to make deposits to their accounts. Furthermore, the present invention does not require any modification of the transaction processing system 111; but rather utilizes a feature designed to credit debit card 100 accounts for a previously debited amount, without requiring that the previous debit transaction have occurred.

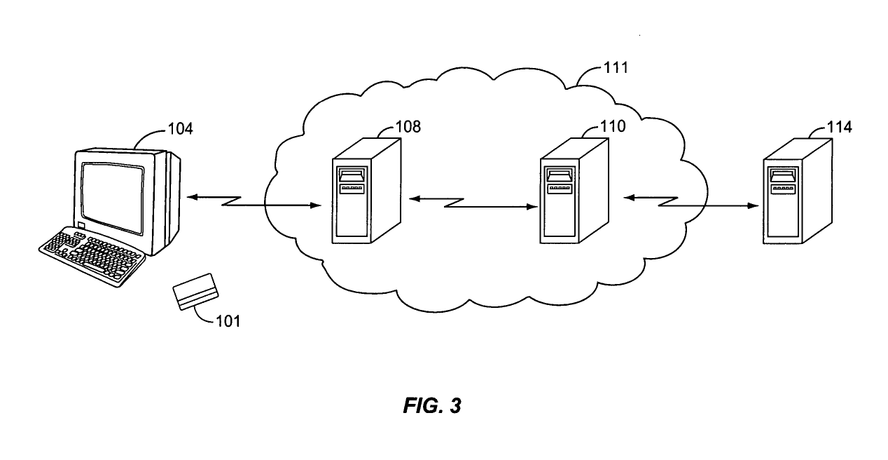

FIG. 3 depicts a computer network operative to carry out the deposit of the present invention. A POS terminal 104 is operative to obtain account information from a debit card 101 and an amount of funds designated for deposit. The POS terminal 104 is communicatively coupled to a transaction processing system 111 comprising at least a transaction processing terminal 108, such as at a merchant bank, that is communicatively coupled to a transaction server 110. The transaction server 110 is communicatively coupled to an account access terminal 114, such as at the customer's financial institution. The POS terminal 104, transaction processing system 111 and account access terminal 114 are operative to transfer electronic signals representing funds transfers, including authorization messages and settlement messages (e.g., debit and credit transactions and operations).

As used herein, the term “funds” refers to money assets in whatever form. Funds may comprise cash, one or more negotiable instruments, electronic funds (e.g., electronic credit and debit transactions), and all other forms of money assets as known in the art. In particular, “funds” are not limited by source or destination, and may change form during a chain of transactions. For example, and with reference to FIG. 1, in the case of a customer 100 depositing a negotiable instrument with a retail merchant 102, the funds 122 comprise the negotiable instrument. The merchant bank 106 may provisionally credit the account of the retail merchant 102 for the face value of the negotiable instrument, and immediately send a credit 126, representing at least a portion of the funds 122, to the transaction server 110. Assuming the negotiable instrument clears the national check clearing system 132, the merchant bank receives a credit 134 for the face value of the negotiable instrument, and makes permanent the provisional credit to the account of the retail merchant 102. As the term is used herein, the funds 126 credited to the financial institution 112 are at least a portion of the same funds 122 deposited by the customer 100 with the retail merchant 102 (notwithstanding the fact that the credit 126 forwarded by the merchant bank 106 may have been drawn against an independent source of funds at the merchant bank 106, pending the clearing of the negotiable instrument).

Although the present invention has been described herein with respect to particular features, aspects and embodiments thereof, it will be apparent that numerous variations, modifications, and other embodiments are possible within the broad scope of the present invention, and accordingly, all variations, modifications and embodiments are to be regarded as being within the scope of the invention. The present embodiments are therefore to be construed in all aspects as illustrative and not restrictive and all changes coming within the meaning and equivalency range of the appended claims are intended to be embraced therein.

1. A method of depositing funds to a customer account at a financial institution by a retail merchant, comprising:
accepting funds by a retail merchant from a customer for deposit into at least one customer account at a financial institution;
obtaining from the customer information identifying said customer account; and
depositing at least a portion of said funds into said customer account, the deposit not a credit of previously debited funds.

2. The method of claim 1 wherein said funds accepted by said retail merchant comprise one or more negotiable instruments.

3. The method of claim 2, further comprising paying at least a portion of the funds comprising said negotiable instrument to the customer.

4. The method of claim 1 wherein obtaining from the customer information identifying at least one customer account at a financial institution comprises capturing said information from the customer in a point-of-sale terminal.

5. The method of claim 4 wherein capturing said information in a point-of-sale terminal comprises sensing said information magnetically encoded on a card.

6. The method of claim 4 wherein capturing said information in a point-of-sale terminal comprises sensing said information optically encoded on a card.

7. The method of claim 4 wherein capturing said information in a point-of-sale terminal comprises sensing said information via RF communication with a circuit embedded on a card.

8. The method of claim 4 wherein capturing said information in a point-of-sale terminal comprises reading said information from a circuit embedded on a card.

9. The method of claim 1 further comprising retaining a transaction processing fee from said funds.

10. The method of claim 1 further comprising offering a premium to the customer for one or more purchases made contemporaneously with depositing said funds.

11. The method of claim 1 wherein depositing at least a portion of said funds into said customer account comprises transferring said at least a portion of said funds and said account identification information to said financial institution via a transaction processing system.

12. The method of claim 11 wherein transferring said funds and information via said transaction processing system comprises performing a process provided by said transaction processing system for crediting funds to said account previously debited from said account.

13. The method of claim 11 wherein said transaction processing system crediting process comprises an authorization process and a clearing a settlement process.

14. A method of depositing, by a financial institution, funds received by a retail merchant from a customer of said financial institution, into the customer's account at said financial institution, comprising:
receiving, at said financial institution, information sent by said retail merchant identifying at least one account of a customer of said financial institution;
authorizing a deposit to said account;
receiving funds sent by said retail merchant, said funds received by said retail merchant from the customer; and
depositing at least a portion of said funds into said customer account, the deposit not a credit of funds previously debited from said account.

15. The method of claim 14 wherein receiving information and receiving funds sent by said merchant comprise receiving said information and funds sent by said retail merchant via a transaction processing system.

16. The method of claim 15 wherein receiving said information and funds sent by said merchant via a transaction processing system comprises receiving said information and funds via a process provided by said transaction processing system to credit to said customer account funds previously debited from said account.

17. The method of claim 14 wherein said funds received by said retail merchant comprise a negotiable instrument, and further comprising indemnifying said retail merchant for losses incurred due to failure of said negotiable instrument.

18. The method of claim 14 wherein said retail merchant comprises a plurality of selected retail merchants, said selected merchants located in geographic areas not served by a branch of said financial institution.

19. The method of claim 13 wherein said retail merchant comprises a plurality of related retail merchants.

20. A system for depositing funds received by a retail merchant from a customer into the customer's account at a financial institution, comprising:
a point-of-sale terminal at said retail merchant operative to receive at least information identifying a customer's account at a financial institution and an amount of funds;
an account access terminal at said financial institution operative to receive information identifying the customer's account and credit for at least a portion of said funds, and to credit said account with said received funds; and
a transaction processing system communicatively coupled to said point-of-sale terminal and said account access terminal and operative to transfer a credit for at least a portion of said funds from said point-of-sale terminal to said account access terminal for credit to said account, said credit not a credit of funds previously debited from said account.

21. The system of claim 20 wherein said transaction processing system includes at least one intermediary financial institution.

22. The system of claim 20 wherein said point-of-sale terminal additionally receives a personal identification number from said customer, and wherein said transaction processing system uses said personal identification number to authenticate said funds transfer.

23. A method of operating a transaction processing system by a retail merchant to deposit funds received by said merchant from a financial institution customer into the customer's account at the financial institution, comprising:
receiving from the customer funds and information identifying said customer account; and
performing a procedure via said transaction processing system, provided by said transaction processing system to credit to said customer account funds previously debited via said transaction processing system from said customer account, to deposit at least a portion of said funds in said customer account, said funds not previously debited from said customer account.

24. The method of claim 23 wherein said procedure comprises an authorization process and a settlement process.

25. The method of claim 24 wherein said retail merchant receives a personal identification number from the customer and provides said personal identification number to said transaction processing system, and wherein said financial institution uses said personal identification number in said authorization process.
